(19) United States
(12) Patent Application Publication
(10) Pub. No.: US 2007/0198288 A1
(43) Pub. Date: Aug. 23, 2007

(54) SALES METHOD THROUGH INTERNET

(76) Inventor: Carlos DIAS, Carouge (CH)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 11/677,215

(22) Filed: Feb. 21, 2007

Related U.S. Application Data
(60) Provisional application No. 60/774,547, filed on Feb. 21, 2006.

(51) Int. Cl. G06Q 99/00

(52) U.S. Cl. 705/1

(57) ABSTRACT

The invention is about an internet sales method of goods and services, where a central organisation runs the web site, where the customer orders arrive and are carried out. The stages are of the following type.

Order handling, proposing the customer a leasing contract and to have him sign it with a credit organization under preferably an exclusive contract with the central organization. Preferably, an electronic signature shall validate the transaction. All the stages are carried out directly online via the web site, and the delivery to the customer is carried out either by a local retailer under exclusive contract with the central organisation or by somebody coming directly from the central organization.

The method can also include a stage where the customer can be proposed with an insurance contract with an insurance organization under preferably exclusive contract with the central organization

The current invention is a business method for selling goods over the internet or similar networks, on sales-lease (known commonly as “leasing”)

For the clarity of the following document, we shall simply talk of the “internet” when mentioning the internet or similar networks.

Recently, sales via internet have increased by a large proportion thanks to the ease of use for the buyer as well as for the seller to reach a lot larger amount of population than would be normally inaccessible.

On the other hand, internet services do present a certain problem, in the sense that the manufacturer doesn't have a global view of his customers, which can enable a parallel network to develop beyond his control.

The same thing happens in the luxury goods industry like jewellery, precious stone trading, watch making, clothing and other brand products, with the risk of image loss if the goods are delivered directly to the customers not meeting up to the quality standard that should be expected.

The current invention aims to resolve this sort of problem, allowing the manufacturer and his representative to have the global view of this customers, distributors, the current level of the goods in stock, enabling a better control over the market to rapidly detect the beginning of a “grey” or parallel market, and to take the appropriate measures.

The following invention method proposes a sales system via internet, and a central organization handles the web site that manages the customer orders going through the following stages:

order processing.

proposing the customer with a leasing and making him sign such a contract, preferably exclusive, with a credit organization (bank or credit service), that is under contract, preferably exclusive, with the central organization,

when the leasing contract is signed, preferably electronically, validating the transaction,

all these stages being carried out directly on the website, and

the customer being supplied by a local retailer, who has exclusive rights and is under contract with the central organization, or if not, being supplied directly from a central organization employee.

The favoured execution method would be to have a stage where the customer is proposed to sign a contract with an insurance company that has exclusive rights with the central organization, the order being carried through only when the contract with the insurance company is signed by the customer.

The credit organization and the insurance company can be two separate entities, claiming the payments/premiums separately or together. The two entities could be a unique company i.e. an insurance bank.

Ideally, the central organization should have a global view of the available goods in stock even with the retailers, in order to be able to inform the customer immediately if the goods are available, if not, when and where the availability shall be.

Also, if the customer failed to fulfil the lease contract, it could be bought up by the central organization creating a second hand market. The same goes if the insurance has to intervene to get back its goods. The central organization shall then buy it back from the insurance company.

In such a case, the goods can be resold, after being reconditioned by the manufacturer and having received a new warranty. The sale would follow the method mentioned above.

The resell should be done at a price defined by an official reference, that would follow the market value. The reference could be a document supplied by the manufacturer and/or the central organization.

If the law allows it, there should be a commission for the central organization, that is described in a contract between all involved in the sale/lease.

In other words, it is about carrying out a leasing transaction by a central organization that represents the manufacturer and the web site host. The central organization should be ideally linked legally or economically to the manufacturer. The central organization should have before hand passed a, preferably exclusive, with a credit organization which shall finance the credit-bail, and has also passed a contract with its local retailers, so that the final customer can be delivered correctly. If there is no local retailer, the central organization shall itself find a retailer who can carry out the delivery. By local retailer, we mean a retailer, reseller or manufacturer, exclusive or not locally situated as opposed to the customer that he shall deliver, or very close to him.

Therefore, the customer could also go to the local retailer and withdraw his goods, which could result in further sales, not within the normal network, and direct payment via credit card.

Of course the delivery can be carried out, on request, directly to the customer's door.

Ideally, the central organization will have before hand taken out a contract, preferably exclusive, with the insurance company, so that the delivery is guaranteed through every stage of the process.

It is clear that the central organization can be unique per country as well as for a group of countries, if they of course share the same language and that the central organization can be fractured into smaller entities if the country is large geographically, or densely populated.

One can also have the central organization can be fractured by brand, with each the central organization being responsible for a manufacturers brand, to deliver the best advertising, without risking the image blur, that could happen if the type of products and prices are to spread out.

The principal of leasing is that the goods remain the property of the credit organization, as long as they haven't been fully paid for. If the customer should fail, the goods are recuperated by the credit organization. The contract which links it to the central organization should include a buy back clause, though the product shall return to the manufacturer for reconditioning before being put back on the market, all this using the sales method of the invention.

Following the law of a concerned country, the various contracts between the entities involved, (central organization, the bank, the insurance company, the retailer) can allow commission returns to the central organization after each transaction.

It is understood, that through this way of doing business over the internet, allows the central organization and the manufacturer to better control the market, avoiding a parallel market starting up, and also to monitor its stocks centrally, also creating a customer database that can be used for promotional periods or for selling other products of its range. This possibility is crucial for certain industries, in particular for the luxury industry, jewellery, precious stones, and watch making.

We are now going to describe, in a non limitary example, the method according to the invention in a favourable situation.

The customer connects to the central organization web site, who is acting on behalf of the manufacturer or the brand, where he would like to make a purchase. The site proposes a range of goods for sale at various prices and with options.

If the customer finds what he is looking for, he shall pass a purchase act, he is then transferred to an interactive page where he is asked for at least his identity, his address, and the reference of the desired goods. The information is stored in the first memory. The address information is then compared with the second memory, which contains the list of all the retailers addresses, so as to find the closest one to the customer.

The reference information of the goods is then compared with a third memory that has the list of retailers but with the available stocks per retailer. If no positive matched information concerning the customer and retailer can be returned, the reference information is then sent to a fourth memory, and compared with the available stock directly at the central organization.

A notice is then sent to the customer on the website informing him that the transaction is being processed, where and when he shall be served, and by whom the transaction is carried out.

In parallel or in sequence, the customer identity and address as well as the price are transferred to a fifth memory at the credit organization, which processes the information, sends it to the central organization to send it on to the customer with various leasing contracts between which the customer can choose from, and his digital signature or a proposed digital signature confirms the choice made. The same thing happens if an insurance company is called to intervene in the transaction using precisely the same information contained in the fifth memory which is transferred into a sixth memory where the insurance company stores its own information.

As soon as the customer has signed the proposed leasing contract, the sale is validated and carried out. A notice is sent back to the website to the customer's attention, giving him the delivery information, where and when he can take delivery of the goods, and at which local official retailer or that the goods shall be directly delivered by Mr. X from the central organization.

Preferably, as soon as a local retailer has been found, a notice is sent to the retailer to temporarily block the reference of the concerned goods. A confirmation message is then sent indicating that the transaction has been completed with the identity information and the address the customer first supplied. This is also happens if the central organization takes charge itself of the delivery.

If the customer does not pass the final order, or if the credit organization does not accept him, a message is sent to the local retailer respectively in the central organization information site that the goods reference can be made available again for other customers.

Each stage totally transparent for the customer who only sees the current welcome screen allowing him to identify himself, to make the choice of bail-contract he prefers, as well as finally validating the transaction. He then receives the relevant delivery information. Of course the site is a secure web site according to the art of rule to protect the customer as well as all involved. Each stage is validated by a keyword and all the whole transaction is encrypted.

To make it more user friendly if a user visits again, the cookie technology is used by the central organization.

1. A sales method via internet or equivalent channels of goods and services in which a central organization uses its internet site to process user orders, is characteristic in the fact that it comprises the following stages of:
order processing,
proposing the customer a leasing purchase and making him sign a credit contract, preferably exclusive, with the central organization,
validating the transaction by a signature, preferably digital,
all this on line via the web site,
then having the goods delivered to the customer via a local retailer who is under contract, preferably exclusive, with the central organization if no local retailer is available, the delivery is carried out directly by one of the central organization's personnel.

2. A method according to claim 1, wherein it comprises, a proposal to the customer to sign a contract, preferably exclusive, with an insurance company, with the central organization, the delivery of goods being carried out only when the insurance contract has also been signed by the customer.

3. A method according to claim 1, wherein the central organization has a global view of its stocks, and can manage them in order to be able to answer the customer on line immediately concerning availability and delivery options.

4. A method according to claim 1, wherein the goods taken back by the bank in the case where the customer fails in carrying out the leasing contract are bought back by the central organization to create a second hand market.

5. A second hand sales method of goods and services internally, wherein the goods have been sold following the method according to claim 1, wherein the goods taken back by the bank in the case where the customer fails in carrying out the leasing contract are bought back by the central organization to create a second hand market, and wherein the resale is carried out following the method according to claim 1.

6. A method according to claim 4, wherein the goods are reconditioned before resale by the manufacturer under the responsibility of the central organization.

7. A method according to claim 4, wherein the resale is carried out at a fixed price found in a referential document stating prices for the second hand market, preferably edited under the responsibility of the manufacturer or the central organisation.

8. A method according to claim 1, wherein the contracts between the central organisation the credit organization and the retailer, respectively the insurance company, have various clauses for the retrocession of a commission in favour of the central organisation.

9. A method according to claim 1, wherein it includes the stages of:
presenting to the customer on the web site of the range of goods for sale with the price and all possible options,
if the customer finds what he's looking for, and wishes to make the purchase, asking him at minimum his identity, his address and the reference of the goods he desires,
storing the information in the first memory,
comparing the address information with the information contained in a second memory to work out who the local retailer or second hand retailer could be,
comparing the referential information in a memory which contains a list of address of recognised retailers and the available stocks for each retailer,
if no match is found between the customer and local retailer can be found, or due to the goods not being available at the local retailer's, sending the information to a fourth memory,
and comparing with a stock list available directly at the central organisation,
sending back to the web site to the customer's attention a notice that his order shall be carried out, where and when and by whom, once the transaction is complete,
at the same time or in sequence transferring information on the customer's identity his address and information on the price of the goods to a fifth memory at the credit organization,
the credit organization sending back to the central organisation's web site to the customer's attention one or more propositions of a leasing contract between which the customer must choose,
and validating his choice using his electronic signature or one proposed directly on line.
the sale being validated and the transaction over once the customer has signed the leasing contract,
and a message being sent to the customer on the web site telling him he can take delivery of the goods from the official local retailer, or that he shall have the goods delivered without delay.

10. A method according to claim 1, wherein as soon as the local retailer has been found, a message is transferred to the retailer's memory that manages the stocks to block the concerned goods temporarily, a confirmation message is then sent to inform that the transaction has been carried out with the customers identity and address for the delivery, or otherwise a message is sent to the local retailer's memory to free the goods, if the customer doesn't finally carry out the order, or that he is not accepted by the credit organization.

11. The use of the method according to claim 1 to internet sales or any similar network of luxury goods, particularly jewellery, watches or precious stones.
